(19) United States
(12) Patent Application Publication
(10) Pub. No.: US 2013/0050859 A1
(43) Pub. Date: Feb. 28, 2013

(54) REARWARD AND FORWARD VIEWING VEHICULAR MIRROR ASSEMBLY

(71) Applicant: Changhyun Shin, Greensboro, NC (US)

(72) Inventor: Changhyun Shin, Greensboro, NC (US)

(73) Assignee: VOLVO GROUP NORTH AMERICA, LLC, Greensboro, NC (US)

(21) Appl. No.: 13/696,324

(22) PCT Filed: May 17, 2010
(86) PCT No.: PCT/US10/35085

§ 371 Date: Nov. 6, 2012

(51) Int. Cl. G02B 5/08

(52) U.S. Cl. 359/850

(57) ABSTRACT

The present invention relates to mirror assembly for a vehicle that includes a cab provided with an operators seat. The mirror assembly is positioned in relation to the cab, whereby the mirror assembly is visible from the operators seat. The mirror assembly includes a housing, a rearward viewing mirror portion, and a forward viewing mirror portion. The housing is provided with an exterior shell surface and an inner shell surface, which defines a cavity. The rearward viewing mirror portion is at least partially received within the cavity of the housing. The forward viewing mirror portion is located on the exterior shell surface of the housing.

### FIELD OF THE INVENTION

The present invention relates to an improved rearward and forward viewing vehicular mirror assembly.

### BACKGROUND OF THE INVENTION

Many vehicles, including over the highway traveling vehicles and construction vehicles are provided with rearward viewing side mounted mirrors, typically located on the left and right sides of the vehicle cab, for example, proximate to the driver and passenger doors. Rearward viewing side mounted mirrors typically include a generally flat mirror, which provides the operator with a view along the rearward lateral sides of the vehicle. Rearward viewing side mounted mirrors may also include one or more additional flat or convex mirrors, which provide an operator with a view of blind spots located along the rearward lateral sides of the vehicle.

While many vehicles are provided with blind spots located along the rearward lateral sides of the vehicle, blind spots may also exist along the forward lateral sides of the vehicle. This is particularly the case for many larger vehicles, such as buses, truck tractors, and other heavy trucks, which are provided with large hood structures. Heretofore, rearward viewing side mounted vehicle mirrors have generally not afforded viewing along the forward lateral sides of the vehicle.

The present invention relates to an improved rearward and forward viewing vehicular mirror assembly.

### SUMMARY OF THE INVENTION

According to one embodiment of the present invention, a vehicle comprises a cab and a mirror assembly. The cab is provided with an operator's seat. The mirror assembly is positioned in relation to the cab, whereby the mirror assembly is visible from the operator's seat. The mirror assembly includes a housing, a rearward viewing mirror portion, and a forward viewing mirror portion. The housing is provided with an exterior shell surface and an inner shell surface that defines a cavity. The rearward viewing mirror portion is at least partially received within the cavity of the housing. The forward viewing mirror portion is located on the exterior shell surface of the housing.

According to another embodiment of the present invention, a vehicle comprises as cab and a mirror assembly. The cab is provided with an operator's seat and a cab lateral side view window. The mirror assembly is positioned in relation to the cab, whereby the mirror assembly is visible through the cab lateral side view window from the operator's seat. The mirror assembly includes a housing, a rearward viewing mirror portion, and a forward viewing mirror portion. The housing is provided with an exterior shell surface and an inner shell surface that defines a cavity. The rearward viewing mirror portion is at least partially received within the cavity of the housing. The forward viewing mirror portion is located on the exterior shell surface of the housing.

### BRIEF DESCRIPTION OF THE DRAWINGS

FIG. 1 shows a forward perspective view of a vehicle provided with mirror assemblies according to one embodiment of the present invention.

FIG. 2 shows a side view of a vehicle provided with mirror assemblies according, to one embodiment of the present invention.

FIG. 3 shows a top view of a vehicle provided with mirror assemblies according to one embodiment of the present invention.

FIG. 4 shows a close up view of a mirror assembly according to one embodiment of the present invention.

FIG. 5 shows a close up view of a minor assembly according to one embodiment of the present invention.

FIG. 6 shows a close up view of a mirror housing according to one embodiment of the present invention.

FIG. 7 shows a close up view of a mirror assembly according to one embodiment of the present invention.

### DETAILED DESCRIPTION OF THE INVENTION

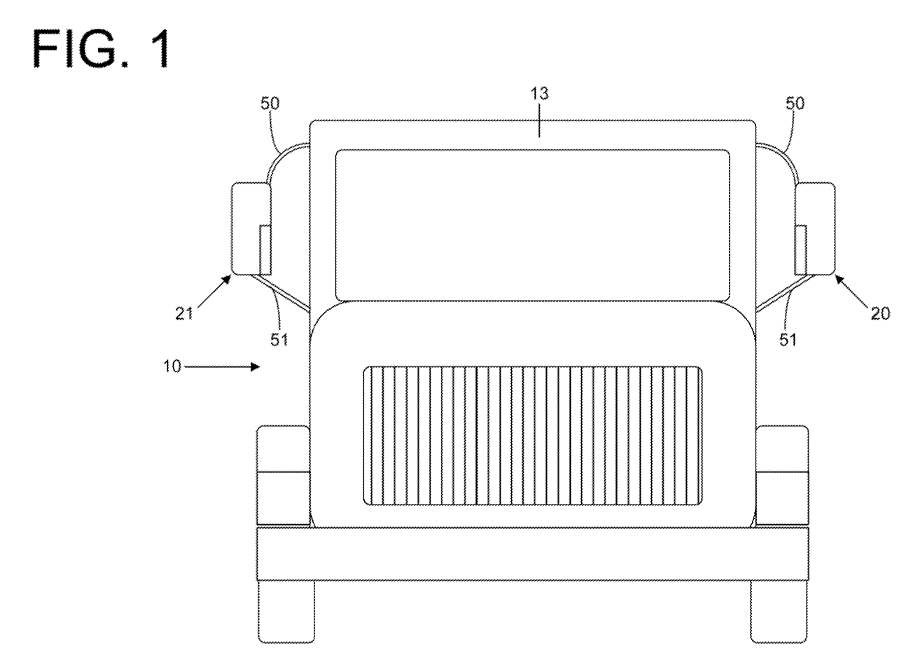

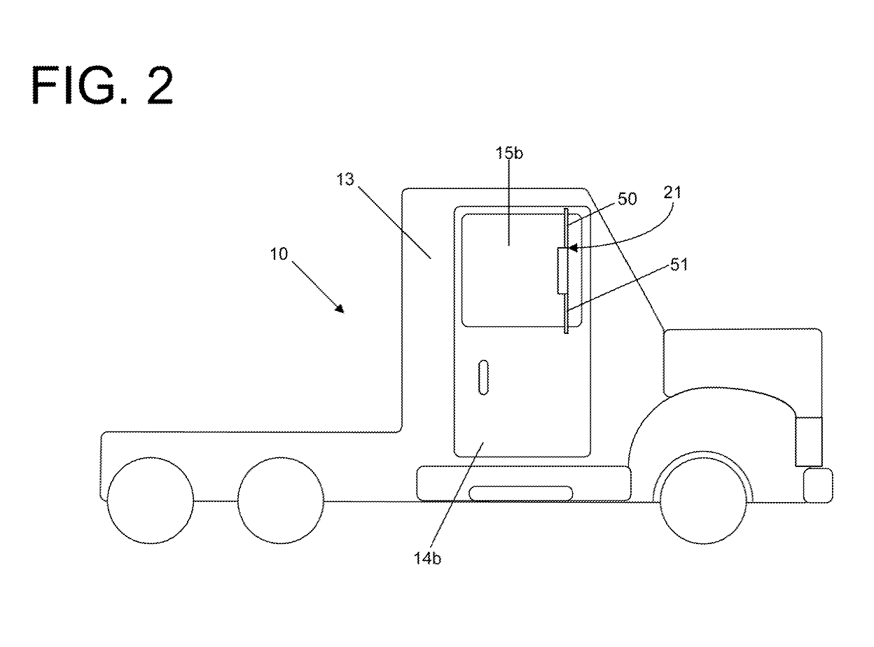

FIGS. 1-3 depict a vehicle 10 provided with mirror assemblies 20, 21 according to one embodiment of the present invention. As shown, the vehicle 10 may, for example, and not limitation, be a conventional truck tractor, however, those of ordinary skill in the art will appreciate that it is within the scope of the present invention to utilize one or more of the mirror assemblies 20, 21 in conjunction with any type of vehicle, including, but not limited to automobiles, buses light trucks, and heavy trucks. Furthermore, although the present embodiment is shown with first and second mirror assemblies 20, 21, those of ordinary skill in the art will appreciate that it is within the scope of the present invention to employ a single mirror assembly 20 or 21.

In the present embodiment, the mirror assemblies 20, 21 are shown preferably located along both the driver and passenger sides of the cab 13 of the vehicle 10 and mounted to respective lateral cab sides 11, 12 of the vehicle 10. Those of ordinary skill in the art will appreciate that the mirror assemblies 20, 21 are positioned to be visible from the operator's seat 16 and to an operator 14 situated in the interior of the vehicle cab 13.

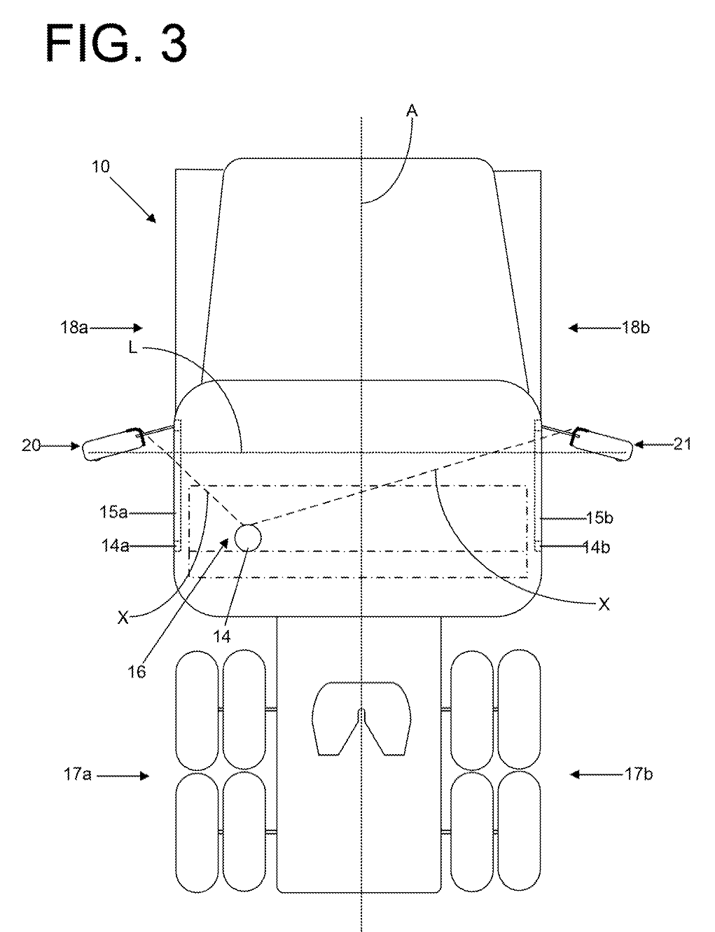

According to one aspect of the present embodiment, the mirror assemblies 20, 21 may be connected to the cab 13 of the vehicle 10. According to yet another aspect of the present embodiment, the mirror assemblies 20, 21 may be connected to the vehicle 10 in any manner that positions the mirror assemblies 20, 21 laterally outward from the cab 13 of the vehicle 10. For example, as shown in FIG. 3, the mirror assemblies 20, 21 may be positioned laterally outward from the cab 13 of the vehicle 10 whereby a line L, which extends generally orthogonal to a longitudinal axis A of the vehicle 10, may pass through at least a portion of the mirror assembly 20 and minor assembly 21 and at least a portion of the cab 13.

According to one aspect of the present embodiment, the mirror assemblies 20, 21 may be connected to the driver and passenger side doors 14a, 14b of the vehicle 10, whereby the mirror assemblies 20, 21 are visible from the operator's seat 16. According to another aspect of the present embodiment, the mirror assemblies 20, 21 may be mounted to the exterior of the cab 13 forward of the driver and passenger side doors 14a, 14b, whereby they are visible from the operator's seat 16. According to yet another aspect of the present embodiment, the mirror assemblies 20, 21 may be connected to the vehicle 10 in any manner that positions the mirror assemblies 20, 21 in relation to the cab 13, whereby the mirror assemblies 20, 21 are visible through the cab lateral side view windows 15a, 15b from the operator's seat 16. For example, as shown in FIG. 3, mirror assemblies 20, 21 may be positioned in relation to cab lateral side view windows 15a, 15b whereby field of vision lines X extend from the mirror assemblies 20, 21 through the windows 15a, 15b and to the operator's seat 16 in a manner whereby a operator 14 may view the minor assemblies 20, 21 while occupying the operator's seat 16. In the present embodiment, wherein the mirror assemblies 20, 21 are located on a vehicle in the form of a tractor truck, those of ordinary skill in the art will appreciate that the cab lateral side view windows 15a, 15b correspond to driver and passenger windows.

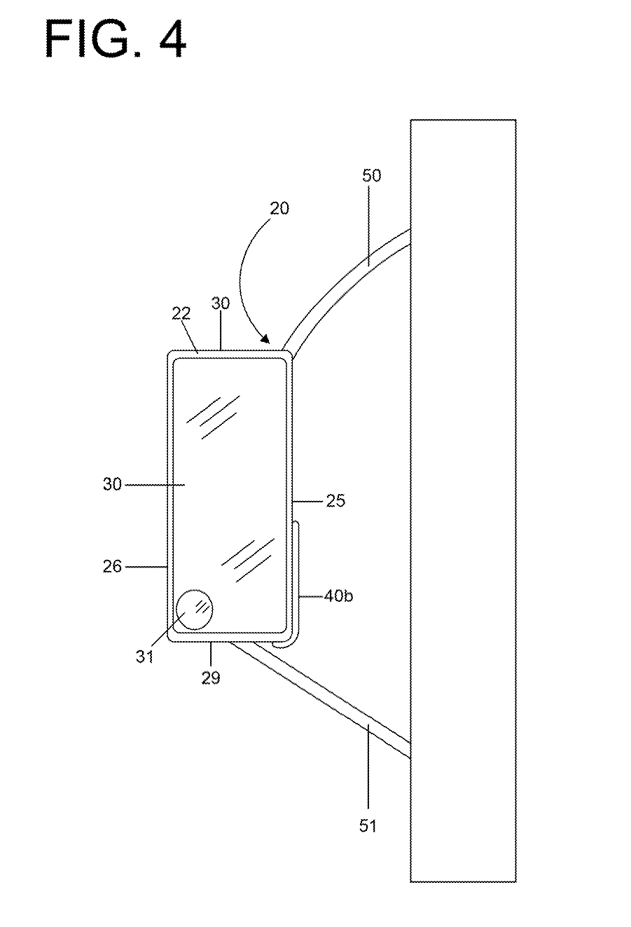

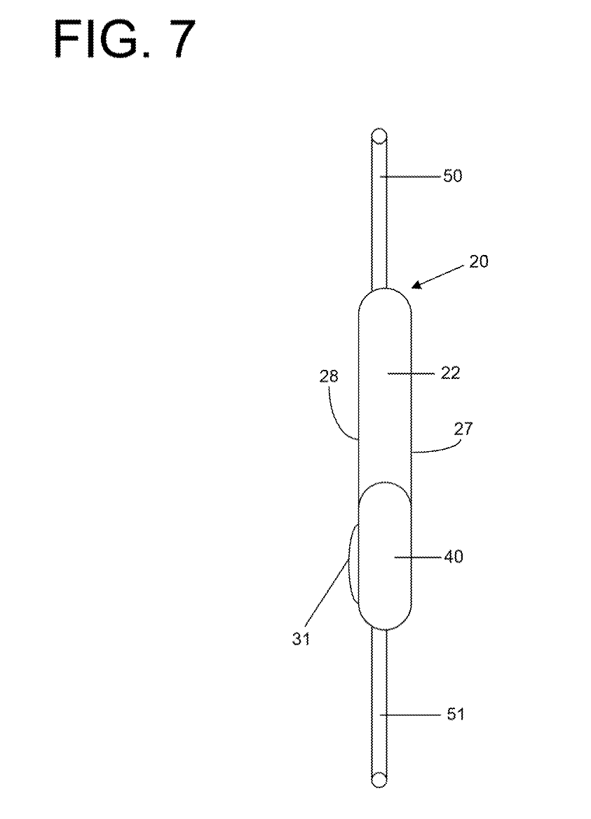

Turning now to FIGS. 4-7, the mirror assemblies 20, 21 of the present embodiment are shown provided with a mirror housing 22, at least one rearward viewing mirror portion 30, at least one forward viewing mirror portion 40, and at least one connecting arm 50.

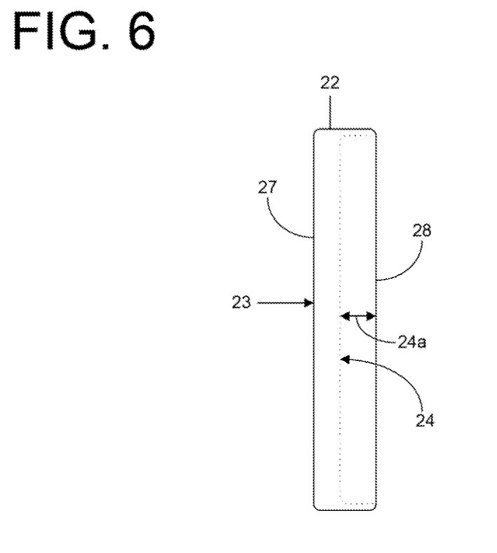

FIGS. 4-6 depict the mirror housing 22 according to one embodiment As shown, the mirror housing 22 is provided with exterior shell surface 23 and an inner shell surface 24, which defines a cavity 24a (FIG. 6). Also shown, the mirror housing 22 may be provided with a proximal side 25, a distal side 26, a forward facing side 27, and a rearward facing side 28, an underside 29, and a top side 30. As shown, the proximal side 25 is positioned laterally closer to the vehicle 10 than the distal side 26. Also shown, the distal side 26 is positioned laterally further from the vehicle 10 than the proximal side. As shown, the forward facing side 27 and rearward facing side 28 extend outward from the proximal side 25 to the distal side 28. As shown in FIG. 6, in the present embodiment the reward facing side 28 defines an inner cavity 24a and the proximal side 25, distal side 26, forward facing side 27, underside 29, and top side 30 define an exterior shell surface 23 that extends around the inner shell surface 24.

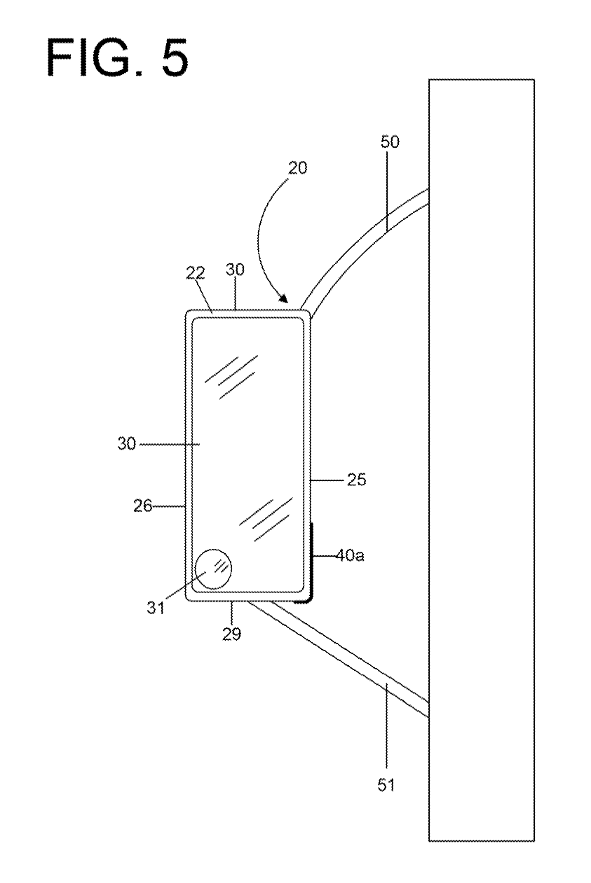

As shown in FIGS. 4 and 5, at least one arm, such as, for example, arms 50, 51 are provided to connect the mirror housing 22 to the vehicle 10. The arms 50, 51 may be integral to the exterior shell surface 23 or fabricated separately and attached to the mirror housing 22. Those of ordinary skill in the art will appreciate that any number of configurations may be employed within the scope of the present invention for purposes of connecting the mirror housing 22 to the vehicle. In the present embodiment a first arm 50 extends outward from the vehicle 10 and is shown coupled to the underside 29 of the mirror housing 22 and a second arm 51 extends outward from the vehicle 10 and is shown coupled to the top side 30 of the mirror housing 25; however, those of ordinary skill in the art will appreciate that this arrangement represents one of many examples within the scope of the present invention.

According to one aspect of the present embodiment, the mirror assemblies 20, 21 are configured to provide an operator located in the operator's seat 16 of the vehicle 10 with a field of view along the rearward lateral sides 17a, 17b of the vehicle 10. Those of ordinary skill in the art will appreciate that the term rearward lateral side 17a, 17b of the vehicle 10 may include the area along the rearward lateral sides of the vehicle 10, but may also include the area along the rearward lateral sides of any trailer or trailers that are towed by the vehicle 10. According to another aspect of the present embodiment, the mirror assemblies 20, 21 are configured to provide an operator located in the operator's seat 16 of the vehicle 10 with a field of view along the forward lateral sides 18a, 18b of the vehicle 10.

According to one aspect of the present embodiment, the mirror housing 22 functions as a support for at least one rearward viewing mirror portion 30. In the present embodiment, the rearward viewing mirror portion 30 is at least partially received or fitted within the inner cavity 24a (FIG. 6) defined by the housing 22. As shown, the rearward viewing mirror portion 30 is provided on the rearward facing side 28 and may extend from the proximal side 25 to the distal side 26. Those of ordinary skill in the art will appreciate that the cavity 24a may have a variety of depths within the scope of the present invention. Furthermore, those of ordinary skill in the art will appreciate that the cavity 24a may accommodate as variety of mechanisms, including mechanical and electrical mechanisms (not shown), for allowing the rearward viewing mirror portion 30 to swivel within the housing 22 whereby the position of the mirror relative to the housing 22 may be adjusted to adjust the viewing angle.

According to one aspect of the present embodiment, the rearward viewing mirror portion 30 is configured to provide an operator located in the operator's seat 16 of the vehicle 10 with a field of view along the rear lateral sides 17a, 17b of the vehicle 10. In the present embodiment shown, the rearward lateral sides 17a, 17b of the vehicle 10 corresponds to an area rearward of the cab 13 and along the lateral sides 11, 12 of the vehicle 10 or any trailer attached to the vehicle.

The rearward viewing mirror portion 30 may be fabricated from any suitable material, such as, for example, a glass or plastic material substrate coated with a highly reflective mirror-finish coating, such as, for example, a coating including silver or aluminum. The glass or plastic material substrate may be affixed or connected to the mirror housing 22 in any manner. Alternatively, the mirror housing 22 may itself function as a substrate for the highly reflective mirror-finish coating.

Those of ordinary skill in the art will appreciate that the rearward viewing mirror portion 30 may be provided with a variety of different shapes, including flat, convex, or concave. Furthermore, those of ordinary skill in the art will appreciate that additional rearward viewing mirror portions, such as, for example, rearward viewing mirror portion 31, may he provided on the mirror assemblies 20, 21. In the present embodiment, a first rearward viewing mirror portion 30 is shown generally flat and a second rearward viewing mirror portion 31 is shown generally convex. Accordingly, in the present embodiment, the first rearward viewing mirror portion 30 provides a conventional rear view whereas the second rearward viewing mirror portion 31 provides a view of a rearward blind spot, which is not shown by the first rearward viewing mirror portion 30.

According to one aspect of the present embodiment, the mirror housing 22 functions as a support for at least one forward viewing mirror portion 40. Turning now to FIGS. 1, 3-5, and 7, in the embodiment shown, the proximal side 25, the forward side 27, and the underside 29 of the exterior shell surface 23 of the mirror housing 22 are provided with at least one forward viewing mirror portion 40.

According to another aspect of the present embodiment, the forward viewing mirror portion 40 is configured to provide an operator located in the operator's seat 16 with a field of view along the forward lateral sides 18a, 18b of the vehicle 10. In the present embodiment, the forward lateral sides 18a, 18b of the vehicle 10 corresponds to an area forward of the cab 13 and along the lateral sides 18a, 18b of the vehicle 10.

According to yet another aspect of the present embodiment, the forward viewing mirror portion 40 includes a highly reflective mirror-finish coating, which may be provided with a contour that substantially corresponds to the contour of a portion of the exterior shell surface to which the forward viewing mirror portion is located on. As shown in FIG. 5, preferably, the forward viewing mirror portion 40 is provided by applying the highly reflective mirror-finish coating 40a directly on the exterior shell surface 23 of the mirror housing 22, whereby the mirror housing 22 functions as a substrate for the highly reflective mirror finish coating. Alternatively, as shown in FIG. 4, the highly reflective mirror-finish coating may be applied to a substrate 40b, which is then affixed or connected to the exterior shell surface 23 of the mirror housing 22.

In the present embodiment, wherein the region of the exterior shell surface 23 in the area of the transition between the proximal side, 25, the forward side 27, and the underside 29 is generally convex, the forward viewing mirror portion 40 is shown provided with a corresponding convex shape; however, those of ordinary skill in the art will appreciate that it is within the scope of the present invention to provide alternative arrangements, including arrangements wherein the shape of the forward viewing mirror portion 40 differs from the contour of the portion of the exterior shell surface 23 to which the forward viewing mirror portion 40 is affixed.

Those of ordinary skill in the art will appreciate that it is within the scope of the present invention to provide the forward viewing mirror portion 40 with a variety of different shapes, including flat, convex, and concave. Further while the present embodiment shows the forward viewing mirror portion 40 located on the proximal side 25, the forward side 27, and the bottom side 29, in other embodiments, the forward viewing mirror portion 40 may he provided in a number of configurations so long as a forward view is provided. By way of just one example, and not limitation, those of ordinary skill in the art will appreciate that it is within the scope of the present invention to locate the forward viewing mirror portion 40 on other portions of the exterior shell surface 23 than shown. By way of example, the forward viewing mirror portion 40 may extend onto the top side 30 of the exterior shell surface 23 of the mirror housing 22. Moreover, those of ordinary skill in the art will also appreciate that it is within the scope of the present invention to provide the exterior shell surface 23 with multiple forward viewing mirror portions.

The present description depicts specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Furthermore, the detailed descriptions of the above embodiments are not exhaustive descriptions of all embodiments contemplated by the inventors to be within the scope of the invention. Persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention is determined from the appended claims.

I claim:

1. A vehicle, comprising:
a cab provided with an operator's seat;
a mirror assembly positioned in relation to the cab, whereby the mirror assembly is visible from the operator's seat, wherein the mirror assembly includes:
a housing provided with an exterior shell surface and an inner shell surface that defines a cavity;
a rearward viewing mirror portion at least partially received within the cavity of the housing; and
a forward viewing mirror portion that is located on the exterior shell surface of the housing.

2. The vehicle according to claim 1, wherein the housing includes a proximal side and a distal side, wherein:
the rearward viewing mirror portion extends from the proximal side to the distal side; and
the forward viewing mirror portion is located on the proximal side.

3. The vehicle according to claim 1, wherein the housing includes a proximal side, a forward facing side, and a rearward facing side, wherein:
the rearward viewing mirror portion is located on the rearward facing side; and
the forward viewing mirror portion is located on the proximal side and the forward facing side.

4. The vehicle according to claim 1, wherein the housing includes a proximal side, a forward facing side, a rearward facing side, a bottom side, and a top side wherein:
the rearward viewing mirror portion is located on the rearward facing side; and
the forward viewing mirror portion is located on the proximal side, the forward facing side, and the bottom side.

5. The vehicle according to claim 1, wherein the mirror assembly is attached to the cab of the vehicle.

6. The vehicle according to claim 1, wherein the mirror assembly is attached to a door of the vehicle.

7. The vehicle according to claim 1, wherein the forward viewing mirror portion is provided with a highly reflective mirror-finish coating having a contour that substantially corresponds to a contour of a portion of the exterior shell surface to which the forward viewing mirror portion is located on.

8. The vehicle according to claim 1, wherein the forward viewing mirror portion includes a highly reflective mirror-finish coating that is directly applied onto the exterior shell surface of the mirror housing, whereby the mirror housing functions as a substrate for the highly reflective mirror finish coating.

9. The vehicle according to claim 1, wherein the forward viewing mirror portion includes a highly reflective mirror-finish coating applied to a substrate, which is affixed or connected to the exterior shell surface of the mirror housing.

10. The vehicle according to claim 1, wherein the forward viewing mirror portion is provided with a generally convex shape.

11. A vehicle, comprising:
a cab provided with an operator's seat and a cab lateral side view window;
a mirror assembly positioned in relation to the cab of the vehicle, whereby the mirror assembly is visible through the cab lateral side view window from the operator's seat, wherein the mirror assembly includes:
a housing provided with an exterior shell surface and an inner shell surface that defines a cavity;
a rearward viewing mirror portion at least partially received within the cavity of the housing; and
a forward viewing mirror portion that is located on the exterior shell surface of the housing.

12. The vehicle according to claim 11, wherein the housing includes a proximal side and a distal side, wherein:
the rearward viewing mirror portion extends from the proximal side to the distal side; and
the forward viewing mirror portion is located on the proximal side.

13. The vehicle according to claim 11, wherein the housing includes a proximal side, a forward facing side, and a rearward facing side, wherein:
the rearward viewing mirror portion is located on the rearward facing side; and
the forward viewing mirror portion is located on the proximal side and the forward facing side.

14. The vehicle according to claim 11, wherein the housing includes a proximal side, a forward facing side, a rearward facing side, a bottom side, and a top side wherein:
the rearward viewing mirror portion is located on the rearward facing side; and
the forward viewing mirror portion is located on the proximal side, the forward facing side, and the bottom side.

15. The vehicle according to claim 11, wherein the mirror assembly is attached to the cab of the vehicle.

16. The vehicle according to claim 11, wherein the mirror assembly is attached to a door of the vehicle.

17. The vehicle according to claim 11, wherein the forward viewing mirror portion is provided with a highly reflective mirror-finish coating having a contour that substantially corresponds to a contour of a portion of the exterior shell surface to which the forward viewing mirror portion is located on.

18. The vehicle according to claim 11, wherein the forward viewing mirror portion includes a highly reflective mirror-finish coating that is directly applied onto the exterior shell surface of the mirror housing, whereby the mirror housing functions as a substrate for the highly reflective mirror finish coating.

19. The vehicle according to claim 11, wherein the forward viewing mirror portion includes a highly reflective mirror-finish coating applied to a substrate, which is affixed or connected to the exterior shell surface of the mirror housing.

20. The vehicle according to claim 11, wherein the forward viewing mirror portion is provided with a generally convex shape.
